(19) United States
(12) Patent Application Publication
(10) Pub. No.: US 2016/0040643 A1
(43) Pub. Date: Feb. 11, 2016

(54) TANDEM SOLENOID STARTER HAVING HELICAL PINION GEAR AND STARTING SYSTEMS INCORPORATING THE SAME

(71) Applicant: BorgWarner Inc., Auburn Hills, MI (US)

(72) Inventor: Brett M. Peglowski, Oakland, MI (US)

(21) Appl. No.: 14/454,021

(22) Filed: Aug. 7, 2014

(51) Int. Cl. F02N 11/14

(52) U.S. Cl. CPC F02N 11/14

(57) ABSTRACT

A starter assembly for rotating a helical ring gear of an engine, including a connector with first and second inputs, an electric motor, a helical pinion gear, and an actuator. The motor is in communication with the first input for generating rotational torque in response to signals at the first input. The helical pinion is in rotational communication with the motor. The actuator is in communication with the second input and moves between a disengaged position, with the helical pinion spaced from the helical ring; and an engaged position, wherein the helical pinion meshes and can rotate with the helical ring. The actuator moves between the positions in response to signals occurring at the second input. The inputs are independent such that the actuator can move the helical pinion to the engaged position and the motor can subsequently rotate the helical ring so as to start the engine.

### BACKGROUND OF INVENTION

1. Field of Invention

The present invention relates, generally, to powertrain starting systems and, more specifically, to a tandem solenoid starter assembly having a helical pinion gear and starting systems incorporating the same.

2. Description of the Related Art

Conventional automotive powertrain starting systems known in the art typically include an internal combustion engine controlled by an Engine Control Unit (ECU). The engine generates rotational torque through a crankshaft which is typically in rotational communication with a transmission. A ring gear is typically disposed between the engine and transmission. Depending on the type of transmission, the ring gear may be integrated on a clutch flywheel, a flexplate to which a torque converter or modular clutch assembly is attached, or on any powertrain component in rotational communication with the crankshaft. The ring gear cooperates with a pinion gear of a starter motor to rotate the engine at startup. To that end, conventional starter motors tend to simultaneously rotate and move the pinion gear into engagement with the ring gear, creating a distinctive noise as teeth of the rotating pinion gear engage teeth of the stationary ring gear.

Each of the components of a powertrain starting system of the type described above must cooperate to effectively start the engine. In addition, each of the components must be designed not only to facilitate improved performance and efficiency, but also so as to reduce the cost and complexity of manufacturing and assembling the system. While starting systems known in the related art have generally performed well for their intended purpose, there remains a need in the art for a starting system that has superior operational characteristics, and, at the same time, reduces the cost and complexity of manufacturing the components of the system, as well as the amount of noise generated in operation.

### SUMMARY OF THE INVENTION

The present invention overcomes the disadvantages in the related art in a starter assembly for selectively translating rotational torque to a helical ring gear in rotational communication with an engine. The starter assembly includes a connector, an electric motor, a helical pinion gear, and an actuator. The connector has first and second electric inputs. The electric motor is in electrical communication with the first electric input for selectively generating rotational torque in response to predetermined electric signals occurring at the first electric input. The helical pinion gear is in rotational communication with the electric motor. The actuator is in electrical communication with the second electric input for selectively moving the helical pinion gear between: a disengaged position, wherein the helical pinion gear is spaced from the helical ring gear; and an engaged position, wherein the helical pinion gear at least partially meshes with the helical ring gear and is in rotational communication therewith. The actuator moves the helical pinion gear between the positions in response to predetermined electric signals occurring at the second electric input. The first and second electric inputs are independent, such that the actuator can move the helical pinion to the engaged position and the electric motor can subsequently translate rotational torque to the helical ring gear so as to start the engine.

In addition, the present invention is directed toward a system for selectively starting an engine in rotational communication with a transmission. The system includes a helical ring gear and a starter motor assembly. The helical ring gear is in rotational communication with one of the engine and the transmission. The starter motor assembly selectively translates rotational torque to the helical ring gear. The starter assembly includes a connector having first and second electric inputs, an electric motor, a helical pinion gear, and an actuator. The electric motor is in electrical communication with the first electric input for selectively generating rotational torque in response to predetermined electric signals occurring at the first electric input. The helical pinion gear is in rotational communication with the electric motor. The actuator is in electrical communication with the second electric input for selectively moving the helical pinion gear between: a disengaged position, wherein the helical pinion gear is spaced from the helical ring gear; and an engaged position, wherein the helical pinion gear at least partially meshes with the helical ring gear and is in rotational communication therewith. The actuator moves the helical pinion gear between the positions in response to predetermined electric signals occurring at the second electric input. The first and second electric inputs are independent such that the actuator can move the helical pinion to the engaged position and the electric motor can subsequently translate rotational torque to the helical ring gear so as to start the engine.

Further, the present invention is directed toward a method of starting and operating an engine. The method includes the steps of: providing a power source; providing a helical ring gear in rotational communication with the engine; providing a starter assembly having: an electric motor in electrical communication with a first electric input; a helical pinion gear in rotational communication with the electric motor; and an actuator in electrical communication with a second electric input for selectively moving the helical pinion gear between a disengaged position wherein the helical pinion gear is spaced from the helical ring gear, and an engaged position wherein the helical pinion gear at least partially meshes with the helical ring gear and is in rotational communication therewith; activating the second electric input with the power source such that the actuator moves to the engaged position; and activating the first electric input with the power source such that the electric motor translates rotational torque to the helical ring gear thereby rotating the engine.

In this way, the present invention significantly reduces the complexity, noise generation, and packaging size of the starting system and its associated components. Moreover, the present invention reduces the cost of manufacturing starters and systems that have superior operational characteristics, such as improved engine performance, control, and efficiency.

### BRIEF DESCRIPTION OF THE DRAWINGS

Other objects, features, and advantages of the present invention will be readily appreciated as the same becomes better understood after reading the subsequent description taken in connection with the accompanying drawing wherein:

FIG. 1 is a partial perspective view of an automotive engine showing a flexplate and a starter, according to one embodiment of the present invention.

FIG. 2 is a partial exploded perspective view of components of the engine of FIG. 1, showing the starter, flexplate, a crankshaft output, and a torque converter.

FIG. 3 is an enlarged partial side sectional view of the starter and flexplate of FIGS. 1 and 2 in a first configuration.

FIG. 4 is an alternate enlarged partial side sectional view of the starter and flexplate of FIG. 3 in a second configuration.

FIG. 5 is an additional alternate enlarged partial side sectional view of the starter and flexplate of FIG. 3 in a third configuration,

### DETAILED DESCRIPTION OF THE INVENTION

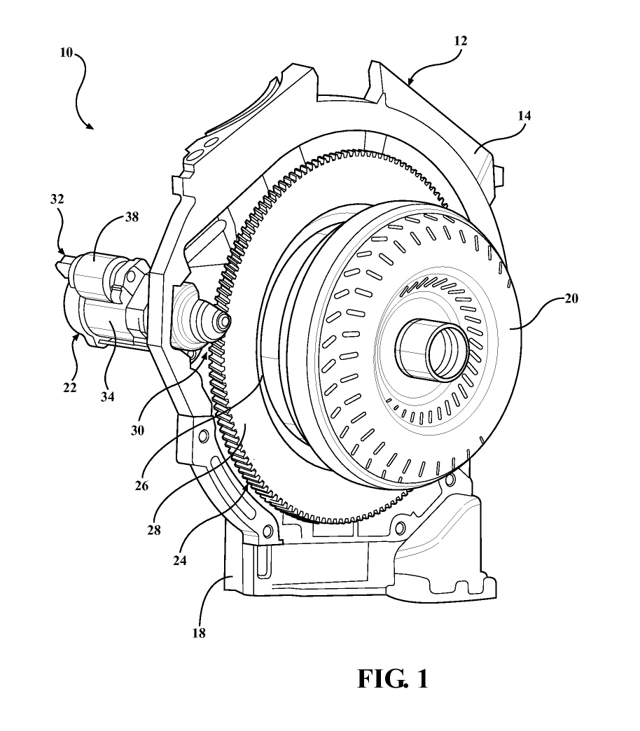

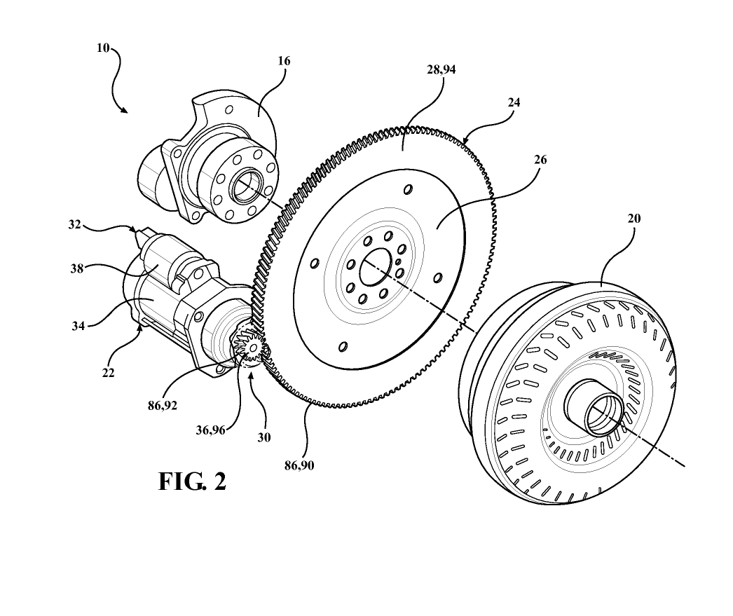

Referring now to the figures, where like numerals are used to designate like structure, a portion of a powertrain of an automobile is illustrated at 10 in FIGS. 1 and 2. The powertrain 10 includes an internal combustion engine 12 operatively attached to a transmission (not shown, but generally known in the art). The engine 12 is adapted to generate and translate rotational torque to the transmission and includes a block 14 and a crankshaft 16 (see FIG. 2) rotatably supported in the block 14. The engine 12 also typically includes an oil pan 18 attached to the block 14. While the engine 12 illustrated in FIGS. 1 and 2 is a V-configured, dual-overhead-cam (DOHC), spark-ignition Otto-cycle engine, those having ordinary skill in the art will appreciate that the engine 12 could be of any suitable configuration controlled using any suitable thermodynamic cycle without departing from the scope of the present invention.

The powertrain 10 also typically includes a disengagement member 20 in rotational communication with the crankshaft 16 for controlling engagement between the engine 12 and transmission. As shown in FIGS. 1 and 2, the disengagement member 20 is a torque converter 20, conventionally used in conjunction with automatic transmissions as well as certain types of continuously-variable transmissions. However, those having ordinary skill in the art will appreciate that the disengagement member 20 could be of any type or configuration suitable to control engagement between the engine 12 and transmission so as to selectively translate rotational torque therebetween, without departing from the scope of the present invention. By way of non-limiting example, the disengagement member 20 could be a clutch assembly (not shown, but generally known in the art) used in conjunction with a manual transmission.

To start the engine 12, a starter assembly 22 (also commonly referred to as a “starter motor” or “starter motor assembly”) is typically operatively attached to one of the engine 12 and the transmission, and is in selective rotational communication with the crankshaft 16. To that end, and according to one embodiment of the present invention, the starter assembly 22 cooperates with a flexplate 24 to rotate the engine 12 at startup. The starter assembly 22 and flexplate 24 will be described in greater detail below.

The flexplate 24 is used to translate rotational torque between the starter assembly 22, the engine 12, and the transmission. To that end, the flexplate 24 includes a mounting portion 26 and a helical ring gear 28. As shown best in FIGS. 1 and 2, the mounting portion 26 of the flexplate 24 is operatively attached to both the crankshaft 16 and the disengagement member 20 (torque converter) and is used to translate rotational torque from the engine 12 to the transmission. However, those having ordinary skill in the art will appreciate that the engine 12 could translate rotational torque to any suitable type of input and, thus, that the starter assembly 22 of the present invention can be used in conjunction with the engine 12 irrespective of the presence of a transmission and/or a disengagement member 20. By way of non-limiting example, it is conceivable that the engine 12 could be connected directly to an output shaft (not shown, but generally known in the art) and could cooperate with the flexplate 24 and starter assembly 22 of the present invention without the use of a transmission or a disengagement member 20, such as in a non-automotive application. Moreover, the flexplate 24 could be integrated with or otherwise formed as a part of the disengagement member 20, such as with a flywheel of a clutch assembly, without departing from the scope of the present invention. Further, it will be appreciated that neither the engine 12 nor the transmission form a part of the starter assembly 22 of the present invention, and are described herein for the purpose of clarity and as an example of one use of the starter assembly 22 in the method described in greater detail below.

As noted above, the flexplate 24 also includes a helical ring gear 28 operatively attached to the mounting portion 26, whereby the helical ring gear 28 is thus in rotational communication with one of the engine 12 and the transmission. The helical ring gear 28 cooperates with the starter motor assembly 22 to define a system 30 for selectively starting the engine 12 in rotational communication with the transmission. More specifically, the starter assembly 22 is used to selectively translate rotational torque to the helical ring gear 28, which is in rotational communication with the engine 12. To that end, the starter assembly 22 includes a connector 32, an electric motor 34, a helical pinion gear 36, and an actuator 38. Each of these components will be described in greater detail below.

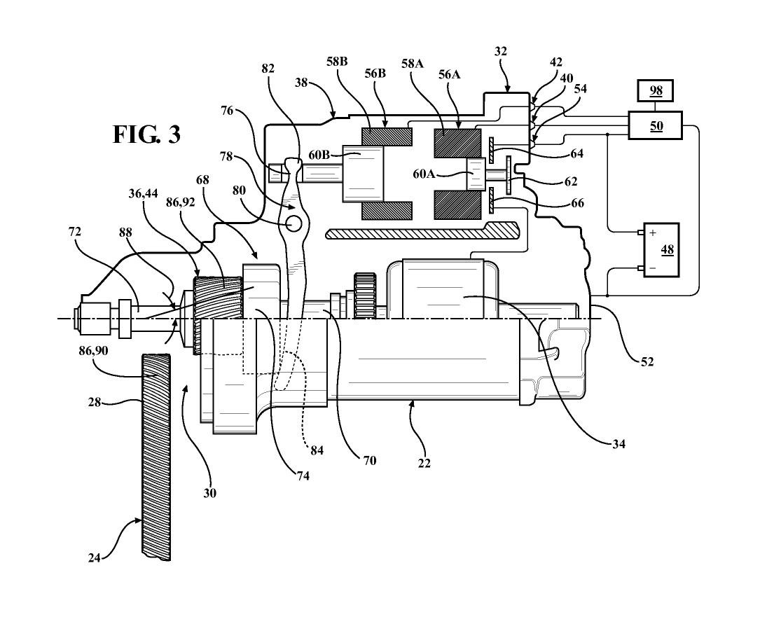

As shown in FIGS. 3-5, the connector 32 of the starter assembly 22 has a first electric input 40 and a second electric input 42. The inputs 40, 42 are adapted to control the electric motor 34 and actuator 38, respectively. To that end, the electric motor 34 is in electrical communication with the first electric input 40 and is used to selectively generate rotational torque in response to predetermined electric signals occurring at the first electric input 40. Moreover, the electric motor 34 is in rotational communication with the helical pinion gear 36, such that rotation and rotational torque can be selectively translated between the electric motor 34 and helical ring gear 28 of the flexplate 24 via the helical pinion gear 36, as described in greater detail below.

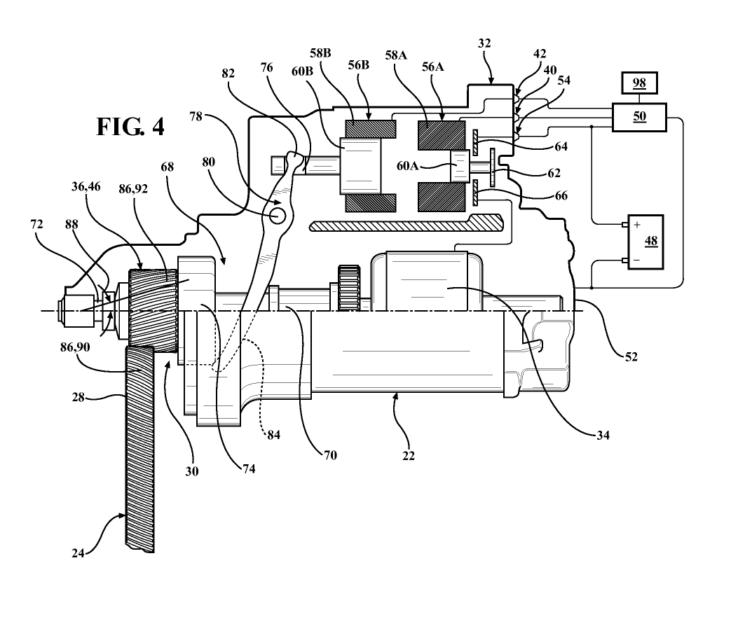

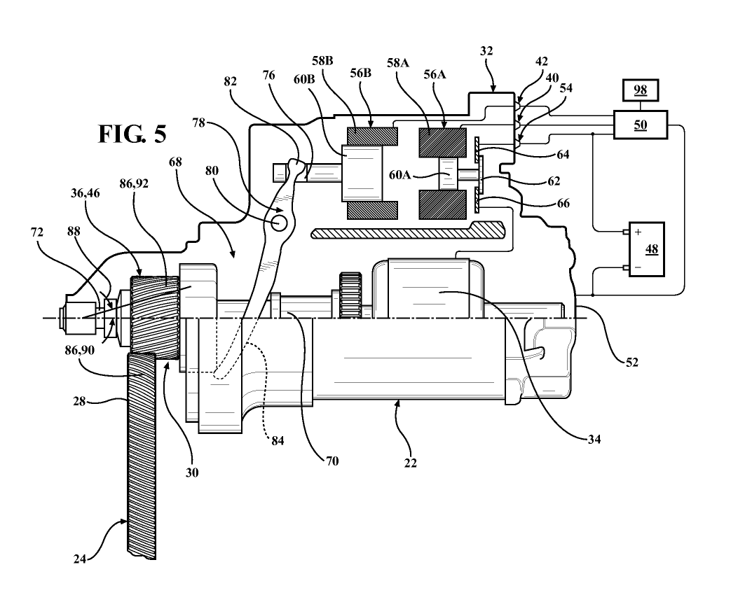

The actuator 38 is in electrical communication with the second electric input 42 and is used to selectively move the helical pinion gear 36 between: a disengaged position 44, wherein the helical pinion gear 36 is spaced from the helical ring gear 28 of the flexplate 24 (see FIG. 3); and an engaged position 46, wherein the helical pinion gear 36 at least partially meshes with the helical ring gear 28 of the flexplate 24 and is in rotational communication therewith (see FIGS. 4 and 5). The actuator 38 moves the helical pinion gear 36 between the positions 44, 46 in response to predetermine electric signals occurring at the second electric input 42. The inputs 40, 42 are independent, such that the actuator 38 can move the helical pinion gear 36 to the engaged position 46 and the electric motor 34 can subsequently translate rotational torque to the helical ring gear 28 so as to start the engine 12. Thus, it will be appreciated that the starter motor 22 of the present invention enables independent control of the rotation and movement of the helical pinion gear 36.

In most automotive applications, the starter assembly 22 is controlled by cooperating with a power supply 48 (such as a battery), and a controller 50, whereby the connector 32 is configured to receive positive voltage signals from the controller 50 at each of the inputs 40, 42 so as to independently rotate and move the helical pinion gear 36, as described above. Moreover, the starter assembly 22 is typically grounded to the engine 12 and the battery 48 via a housing 52, in which the electric motor 34, helical pinion gear 36, and actuator 38 are supported. Similarly, a high-current power terminal 54 connects the starter assembly 22 to positive voltage used to power the electric motor 34. However, those having ordinary skill in the art will appreciate that the starter assembly 22 could be controlled, wired, or otherwise configured to operate in a number of different ways, with any suitable type of electric signal or signals, without departing from the scope of the present invention.

In one embodiment, the starter assembly 22 includes a first solenoid 56A in communication with the first electric input 40 for actuating the electric motor 34, and a second solenoid 56B in communication with the second electric input 42 for actuating the actuator 38. Each of the solenoids 56A, 56B has a coil 58A, 58B surrounding a shaft 60A, 60B. The coils 58A, 58B are connected to ground via the housing 52 (not shown in detail, but generally known in the art), and to the respective inputs 40, 42 of the connector 32, such that the shafts 60A, 60B translate through the coils 58A, 58B in response to a current generated by the predetermined electric signals occurring at the inputs 40, 42, as discussed above. Thus, independent translation of the shafts 60A, 60B allows independent control of the rotation and movement of the helical pinion gear 36.

Referring now to FIGS. 3-5, to effect rotation of the helical pinion gear 36, the first shaft 60A may include a plunger 62 adapted to simultaneously engage first and second contacts 64, 66 connected to the electric motor 34 and high-current power terminal 54, respectively. When the predetermined electric signal occurs at the first input 40 of the connector 32, current flows through the first coil 58A and causes the first shaft 60A to translate along the first coil 58A, thereby connecting the first contact 64 to the second contact 66 via the plunger 62 (compare FIGS. 4 and 5) so that current can flow from the battery 48 to the electric motor 34, which is also typically connected to ground via the housing 52. However, it will be appreciated that the electric motor 34 can be powered in a number of different ways and, thus, the first solenoid 56A could be configured differently, or omitted entirely, without departing from the scope of the present invention.

In one embodiment, the starter assembly 22 further includes a geartrain, generically indicated at 68, disposed between the electric motor 34 and the helical pinion gear 36. The geartrain 68 is supported in the housing 52, is operatively attached to the electric motor 34, and is used to translate rotational torque between the electric motor 34 and helical pinion gear 36. As shown in FIGS. 3-5, the geartrain 68 includes an intermediate shaft 70, a translation shaft 72, and an overrun clutch 74. The helical pinion gear 36 and overrun clutch 74 are typically fixed to the translation shaft 72, which cooperates with the intermediate shaft 70 so as to effect translation of the helical pinion gear 36. To that end, the translation shaft 72 and/or the intermediate shaft 70 may include respective male and female helix portions (not shown, but generally known in the art) so as to radially support the helical pinion gear 36 and cooperate with the actuator 38 to enable selective translation between the positions 44, 46 as described in greater detail below. However, those having ordinary skill in the art will appreciate that the starter motor 22 of the present invention could be configured in any suitable way sufficient to independently rotate and translate the helical pinion gear 36, with or without the geartrain 68 described above.

To effect translation of the helical pinion gear 36 between the disengaged position 44 and the engaged position 46, the second shaft 60B may include an end mount 76 adapted to engage a pivot 78 so as to operatively engage the overrun clutch 74 such that the helical pinion gear 36 translates along the translation shaft 72. To that end, the pivot 78 is pivotally mounted in the starter motor 22 at a mount 80 disposed between a pivot end 82 and a fork 84, which engage the end mount 76 and overrun clutch 74, respectively. When the predetermined electric signal occurs at the second input 42 of the connector 32, current flows through the second coil 58B and causes the second shaft 60B to translate along the second coil 58B, thereby moving the end mount 76 against the pivot end 82, which rotates the pivot 78 along the mounting portion 80 and causes the fork 84 to engage the overrun clutch 74, thereby moving the helical pinion gear 36 between the disengaged position 44 and engaged position 46 (compare FIGS. 3 and 4). However, it will be appreciated that the helical pinion gear 36 can be moved between the disengaged position 44 and engaged position 46 in a number of different ways via any suitable type of actuator 38 and, thus, the second solenoid 56B could be configured differently, or omitted entirely, without departing from the scope of the present invention.

In one embodiment, the starter motor 22 is configured such that the electric motor 34 ceases rotation when the helical pinion gear 36 moves from the engaged position 46 to the disengaged position 44. To that end, the controller 50 may simultaneously send predetermined signals to the first electric input 40 and second electric input 42 of the connector 32. By way of non-limiting example, the controller 50 could simultaneously cease powering the inputs 40, 42 such that the solenoids 56A, 56B become unpowered and thereby cause the shafts 60A, 60B to return, thereby moving: the plunger 62 away from the contacts 64, 66; and the end mount 76, such that the pivot 78 rotates about the mounting portion 80.

As noted above, the starter motor 22 and starting system 30 of the present invention enables independent rotation and translation of the helical pinion gear 36. Thus, the helical pinion gear 36 can independently mesh with and rotate the helical ring gear 28 of the flexplate 24 so as to start the engine 12. To that end, the helical pinion gear 36 and the helical ring gear 28 each include a plurality of helical teeth 86 spaced diagonally with respect to gear rotation, which improves tooth-to-tooth engagement and thereby allows flexibility with respect to the design, spacing, size, and orientation of the helical ring gear 28 and helical pinion gear 36. Moreover, the helical profiles of the teeth 86 significantly reduces noise generation, thus enabling the engine 12 to be started quietly, which also contributes to an improved start-stop driving experience. Further, as will be appreciated from the subsequent description of the helical teeth 86 below, the relationship between the helical pinion gear 36 of the starter assembly 22 and the helical ring gear 28 of the flexplate 24 enables improved flexibility in the design, sizing, and orientation of the starter assembly 22 and the flexplate 24, whereby the overall weight and packaging size of the system 30 can be reduced. More specifically, while the helical pinion gear 36 and helical ring gear 28 typically rotate parallel to each other (see FIG. 2), the flexibility afforded by the present invention allows the starter assembly 22 to be oriented differently, such that the helical pinion gear 36 could engage the helical ring gear 28 at an angle. By way of non-limiting example, the helical pinion gear 36 could engage the helical ring gear 28 perpendicularly.

In one embodiment, the helical teeth 86 of the helical pinion gear 36 and helical ring gear 28 are disposed at a helix angle 88 of less than 35-degrees. Further, in one embodiment, the helix angle 88 is greater than 20-degrees. The helix angle 88 of the helical teeth 86 of the helical pinion gear 36 and helical ring gear 28 being within this range improves meshing, optimizes tooth 86 engagement, and reduces noise in operation. Further, the helix angle 88 being within this range contributes to an improved and significantly quieter stop-start driving experience.

Referring now to FIG. 2, in one embodiment, the helical ring gear 28 has a first number 90 of helical teeth 86, the helical pinion gear 36 has a second number 92 of helical teeth 86, and a tooth ratio between the first number 90 of helical teeth 86 and second number 92 of helical teeth 86 is at least 9:1. Further, in one embodiment, the tooth ratio is less than 13:1. The tooth ratio being within this range optimizes the performance of the starting system 30 and allows the starter motor 22 and flexplate 24 to be designed and manufactured so as to optimize packaging size and component weight. Moreover, by optimizing packaging size and component weight, the tooth ratio being with in this range contributes to an overall reduction in the size and weight vehicles, which correspondingly contributes to an increased fuel economy.

In one embodiment, the helical ring gear 28 has a first major diameter 94, the helical pinion gear 36 has a second major diameter 96, and a diameter ratio between the first major diameter 94 and second major diameter 96 is at least 9:1. Further, in one embodiment, the diameter ratio is less than 13:1. The diameter ratio being within this range optimizes the performance of the starting system 30 and allows the starter motor 22 and flexplate 24 to be designed and manufactured so as to optimize packaging size and component weight. Further, by optimizing packaging size and component weight, the diameter ratio being with in this range contributes to an overall reduction in the size and weight vehicles, which correspondingly contributes to an increased fuel economy.

As noted above, the present invention is also directed toward a method of starting and operating an engine 12. The method includes the steps of: providing a power source 48; providing a helical ring gear 28 in rotational communication with the engine 12; providing a starter assembly 22 having: an electric motor 34 in electrical communication with a first electric input 40; a helical pinion gear 36 in rotational communication with the electric motor 34; and an actuator 38 in electrical communication with a second electric input 42 for selectively moving the helical pinion gear 36 between a disengaged position 44 wherein the helical pinion gear 36 is spaced from the helical ring gear 28, and an engaged position 46 wherein the helical pinion gear 36 at least partially meshes with the helical ring gear 28 and is in rotational communication therewith; activating the second electric input 42 with the power source 48 such that the actuator 38 moves to the engaged position 46; and activating the first electric input 40 with the power source 48 such that the electric motor 34 translates rotational torque to the helical ring gear 28 thereby rotating the engine 12.

In one embodiment, the method includes the further step simultaneously deactivating the first and second electric inputs 40, 42 such that the helical pinion gear 36 moves to the disengaged position 44 and ceases rotation. Moreover, in one embodiment, the method includes the further steps of: providing a controller 50 in electrical communication with the power source 48, the first and second electric inputs 40, 42, and the engine 12; providing at least one sensor 98 in electrical communication with the controller 50; stopping rotation of the engine 12 with the controller 50 in response to a predetermined change in the sensor 98; activating the second electric input 42 with the power source 48 in response to a predetermined change in the sensor 98, such that the actuator 38 moves to the engaged position 46; and activating the first electric input 40 with the power source 48 in response to a predetermined change in the sensor 98, such that the electric motor 34 translates rotational torque to the helical ring gear 28 via the helical pinion gear 38 thereby rotating the engine 12. The sensor 98 described above could be any suitable type of sensor in communication with the controller 50 adapted to detect a change in the speed, position, angle, temperature, or pressure of any component in communication with or otherwise integrated as a part of the engine 12. By way of non-limiting example, the sensor 98 could be a throttle position sensor 98 (not shown, but generally known in the art).

In this way, the invention significantly reduces the complexity, cost, and packaging size of starting systems 30, starter motors 22, and associated components. Specifically, it will be appreciated that the present invention provides significant advantages relating to elimination of noise, vibration, and harshness (NVH) traditionally associated with conventional starting systems 30. To that end, the helical ring gear 28 of the flexplate 24 and helical pinion gear 36 of the starter motor assembly 22 cooperate to provide smooth, consistent, and quiet engagement so as to start the engine 12 in operation. Moreover, it will be appreciated that the starter motor assembly 22 and starting system 30 of the present invention can be used in conjunction with any suitable type of engine 12, irrespective of the use of a transmission. Further still, the present invention reduces the cost of manufacturing engine 12 starting systems 30 and starter motor assemblies 22 that have superior operational characteristics, such as improved performance, weight, component life and longevity, and efficiency.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

What is claimed is:

1. A starter assembly for selectively translating rotational torque to a helical ring gear in rotational communication with an engine, said starter assembly comprising:
a connector having first and second electric inputs;
an electric motor in electrical communication with said first electric input for selectively generating rotational torque in response to predetermined electric signals occurring at said first electric input;
a helical pinion gear in rotational communication with said electric motor; and
an actuator in electrical communication with said second electric input for selectively moving said helical pinion gear between:
a disengaged position, wherein said helical pinion gear is spaced from the helical ring gear, and
an engaged position, wherein said helical pinion gear at least partially meshes with the helical ring gear and is in rotational communication therewith;
wherein said actuator moves said helical pinion gear between said positions in response to predetermined electric signals occurring at said second electric input, and
wherein first and second electric inputs are independent such that said actuator can move said helical pinion gear to said engaged position and said electric motor can subsequently translate rotational torque to the helical ring gear so as to start the engine.

2. The starter assembly as set forth in claim 1, further including:
a first solenoid in communication with said first electric input for actuating said electric motor; and
a second solenoid in communication with said second electric input for actuating said actuator.

3. The starter assembly as set forth in claim 1, further including a geartrain disposed between said electric motor and said helical pinion gear for translating rotational torque therebetween.

4. The starter assembly as set forth in claim 1, wherein said helical pinion gear includes a plurality of teeth disposed at a helix angle of less than 35-degrees.

5. The starter assembly as set forth in claim 4, wherein said helix angle is greater than 20-degrees.

6. The starter assembly as set forth in claim 1, wherein said electric motor ceases rotation when said helical pinion gear moves from said engaged position to said disengaged position.

7. A system for selectively starting an engine in rotational communication with a transmission, said system comprising:
a helical ring gear in rotational communication with one of the engine and the transmission, and
a starter motor assembly for selectively translating rotational torque to said helical ring gear, said starter assembly including:
a connector having first and second electric inputs;
an electric motor in electrical communication with said first electric input for selectively generating rotational torque in response to predetermined electric signals occurring at said first electric input;
a helical pinion gear in rotational communication with said electric motor; and
an actuator in electrical communication with said second electric input for selectively moving said helical pinion gear between:
a disengaged position, wherein said helical pinion gear is spaced from said helical ring gear, and
an engaged position, wherein said helical pinion gear at least partially meshes with said helical ring gear and is in rotational communication therewith;
wherein said actuator moves said helical pinion gear between said positions in response to predetermined electric signals occurring at said second electric input, and
wherein first and second electric inputs are independent such that said actuator can move said helical pinion gear to said engaged position and said electric motor can subsequently translate rotational torque to said helical ring gear so as to start the engine.

8. The system as set forth in claim 7, further including:
a first solenoid in communication with said first electric input for actuating said electric motor; and
a second solenoid in communication with said second electric input for actuating said actuator.

9. The system as set forth in claim 7, further including a geartrain disposed between said electric motor and said helical pinion gear for translating rotational torque therebetween.

10. The system as set forth in claim 7, wherein said helical pinion gear and said helical ring gear each include a plurality of teeth disposed at a helix angle of less than 35-degrees.

11. The system as set forth in claim 10, wherein said helix angle is greater than 20-degrees.

12. The system as set forth in claim 7, wherein said helical ring gear has a first number of teeth, said helical pinion gear has a second number of teeth, and a ratio between said first number of teeth and said second number of teeth is at least 9:1.

13. The system as set forth in claim 13, wherein said ratio between said first number of teeth and said second number of teeth is less than 13:1.

14. The system as set forth in claim 7, wherein said helical ring gear has a first major diameter, said helical pinion gear has a second major diameter, and a ratio between said first major diameter and said second major diameter is at least 9:1.

15. The system as set forth in claim 14, wherein said ratio between said first major diameter and said second major diameter is less than 13:1.

16. The system as set forth in claim 7, wherein said electric motor ceases rotation when said helical pinion gear moves from said engaged position to said disengaged position.

17. A method of starting and operating an engine, said method comprising the steps of:
providing a power source;
providing a helical ring gear in rotational communication with the engine;
providing a starter assembly having: an electric motor in electrical communication with a first electric input; a helical pinion gear in rotational communication with said electric motor;
and an actuator in electrical communication with a second electric input for selectively moving said helical pinion gear between a disengaged position wherein said helical pinion gear is spaced from said helical ring gear, and an engaged position wherein said helical pinion gear at least partially meshes with said helical ring gear and is in rotational communication therewith;
activating said second electric input with said power source such that said actuator moves to said engaged position; and
activating said first electric input with said power source such that said electric motor translates rotational torque to said helical ring gear thereby rotating the engine.

18. The method as set forth in claim 17, including the further step of:
simultaneously deactivating said first and second electric inputs such that said helical pinion gear moves to said disengaged position and ceases rotation.

19. The method as set forth in claim 17, including the further steps of:
providing a controller in electrical communication with said power source, said first and second electric inputs, and the engine;
providing at least one sensor in electrical communication with said controller;
stopping rotation of the engine with said controller in response to a predetermined change in said sensor;
activating said second electric input with said power source in response to a predetermined change in said sensor, such that said actuator moves to said engaged position; and
activating said first electric input with said power source in response to a predetermined change in said sensor, such that said electric motor translates rotational torque to said helical ring gear thereby rotating the engine.
